(19) United States
(12) Patent Application Publication
(10) Pub. No.: US 2026/0276879 A1
(43) Pub. Date: Sep. 17, 2026

(54) OPTICAL WAVEGUIDE AND ILLUMINATION DEVICE FOR A FREE AND A RESTRICTED VIEWING MODE WITH SUCH AN OPTICAL WAVEGUIDE

(71) Applicant: SIOPTICA GMBH, Jena (DE)

(72) Inventor: Yannick BOURGIN, IImtal-Weinstrasse (DE)

(73) Assignee: SIOPTICA GMBH, Jena (DE)

(21) Appl. No.: 19/672,729

(22) Filed: May 11, 2026

(30) Foreign Application Priority Data
Nov. 24, 2023 (DE) 10 2023 132 914.6
Feb. 16, 2024 (DE) 10 2024 104 374.1

(51) Int. Cl. F21V 8/00

(52) U.S. Cl. CPC G02B 6/0068

(57) ABSTRACT

The present disclosure relates to a flat optical waveguide having two large surfaces and having narrow sides which connect the large surfaces at their edges. The optical waveguide comprises a plurality of individual lighting means which are arranged in series and which have an average central spacing of p and have radiating surfaces, wherein one of the narrow sides of the optical waveguide is formed as a coupling-in side for light from the lighting means. The optical waveguide furthermore comprises coupling-out elements which are arranged on at least one of the large surfaces of the optical waveguide and/or within its volume, wherein each coupling-out element has at least one functional surface for defined coupling-out of light from the optical waveguide, and in the event of projection onto one of its large surfaces, all coupling-out elements lie completely within a defined region projected onto the large surface.

### CROSS-REFERENCE TO RELATED APPLICATIONS

This application is a continuation of International Application No. PCT/EP2024/083081, filed on Nov. 21, 2024, which claims priority to German Patent Application No. 10 2023 132 914.6, filed on Nov. 24, 2023 and German Patent Application No. 10 2024 104 374.1, filed on Feb. 16, 2024, all of which are hereby incorporated by reference in their entireties.

### TECHNICAL FIELD

In recent years, significant advances have been made in widening a viewing angle of LCDs. However, there are situations in which the relatively large viewing range of a screen can be disadvantageous. Information, such as bank data or other personal details, and sensitive data, on mobile devices, such as notebooks and tablet PCs, becomes increasingly available. Accordingly, people need control over who is allowed to see this sensitive data; they must be able to choose a wide viewing angle to share information on their display with others, e.g., when viewing vacation photos or also for advertising purposes. On the other hand, they need a small viewing angle when they want to handle the image information confidentially.

A similar problem arises in automotive engineering. A driver must not be distracted by image contents, such as digital entertainment programs, when an engine is switched on, while a passenger, however, would like to consume these even during the journey. Thus, a screen that can switch between corresponding display modes is needed.

Additional films based on micro-louvers have already been used for mobile displays to achieve their visual privacy protection. However, these films were not switchable, and they always had to be placed by hand first and then removed again. Also, one must transport them separately to the display when not currently in use. A significant disadvantage of the use of such louver films is further associated with the accompanying light losses.

### BACKGROUND

U.S. Pat. No. 5,956,107 A discloses a switchable light source enabling a screen to operate in multiple modes. Its disadvantage is that all coupling-out of light relies on scattering, thereby achieving only low efficiency and suboptimal light directionality effects. In particular, a generation of a focused light cone is not disclosed in detail.

CN 107734118 A discloses a screen in which a viewing angle is controllably adjusted by means of two backlights. For this purpose, an upper one of two backlights is configured to emit focused light. In an embodiment, a grating comprising opaque and transparent sections is specifically mentioned. However, this presumably also causes the light from the second backlight which must pass through the first backlight toward an LCD panel to be focused as well, thereby significantly narrowing the viewing angle in the public viewing mode, which is actually intended to provide a wide viewing angle.

US 2007/030240 A1 describes an optical element for controlling a propagation direction of light emitted from a backlight. For example, this optical element requires liquid crystals in the form of PDLCs, which are not only expensive but also particularly safety-critical for end-user applications, as PDLC liquid crystals generally require voltages higher than 60 V for their operation.

CN 1987606 A discloses a screen in which a viewing angle is controllably adjusted by means of two backlights. In particular, a “first light plate” is employed, which must be wedge-shaped to enable an intended focused light extraction. Specific details regarding the achievement of a focused coupling-out of light under corresponding angular conditions are not disclosed.

Furthermore, US 2018/0267344 A1 describes an arrangement comprising two flat illumination modules. In this arrangement, light from an illumination module positioned rearward in a viewing direction is focused by a separate structure. After being focused, the light must still pass through a front illumination module, which includes scattering elements. Thus, strong light focusing for view protection cannot be optimally achieved.

Finally, US 2007/0008456 A1 discloses dividing a light emission angle into at least three regions, wherein typically two of these regions are illuminated. It follows therefrom that a privacy screen employing such an illuminated display cannot be viewable from only a single direction.

WO 2015/121398 A1 of the applicant describes a screen with two operation modes, in which scattering particles in a volume of a corresponding light guide are used for switching between operation modes. However, the scattering particles selected there, made of a polymer, generally have a disadvantage that light is coupled out from both large surfaces, whereby approximately half of the useful light is emitted in the wrong direction, namely toward the backlight, and due to the structure, cannot be recycled there to a sufficient extent. Moreover, the scattering particles made of polymer distributed in the volume of the light guide may, under certain circumstances, especially at higher concentrations, lead to scattering effects that reduce the anti-peeping effect in the protected operation mode.

US 2020/012129 A1 discloses a lighting apparatus and a screen that describe two light sources for switching between a narrow and a wide viewing mode. In one embodiment, one of light guides is formed with fibers. In another embodiment, the scattering coupling-out structure of a light guide is limited in a projection direction to specific strips. This is disadvantageous for achieving homogeneous image illumination and typically also causes unwanted Moiré effects in the assembly, for example when interacting with the pixel columns or rows of an LCD panel disposed thereabove.

The aforementioned methods and arrangements generally share a disadvantage that they significantly reduce the brightness of the base display screen, require an active or at least a specialized optical element for mode switching, necessitate a complex and expensive manufacturing process, reduce the resolution in the freely viewable mode, and/or exhibit brightness or uniformity artifacts.

### SUMMARY

An object of the present disclosure is to provide a light guide exhibiting as stable a uniformity of luminance as possible over a large viewing angle range. In contrast, luminance artifacts, such as shadow formation particularly in corners near a coupling-in edge, are to be avoided as far as possible. A further object of the present disclosure is to provide a lighting apparatus which, in cooperation with a screen, enables secure display of information by means of a selectively limited viewing angle, wherein in another operation mode, a free view, as unlimited in viewing angle as possible, is to be possible. The present disclosure is to be implementable with simple means and at the lowest possible cost, so that the advantages of the aforementioned desired light guide are likewise realized. In both operation modes, a resolution as high as possible, and preferably a native resolution of the employed screen, is to be displayed. Furthermore, the solution is designed to achieve the following: introduce as little light loss as possible, maintain high image quality, particularly with regard to uniformity, and achieve as comprehensive a privacy effect with the limited viewing angle as possible.

In the present disclosure, the above object is achieved by a plate-shaped light guide having two large surfaces and narrow sides connecting the large surfaces at their edges, the light guide including a plurality of individual lighting components arranged in a row. The lighting components have an average center-to-center distance of p and emission surfaces, wherein at least one of the narrow sides of the light guide is configured as a coupling-in side for light from the lighting components. The light guide includes coupling-out elements on at least one of the large surfaces and/or within its volume (i.e., the coupling-out elements are arranged or formed thereon and/or therein). Each coupling-out element has at least one functional surface for defined coupling-out of light from the light guide (i.e., light is coupled out from the light guide at the functional surface). In this regard, all coupling-out elements, when the light guide is viewed in a direction toward one of its large surfaces (or, in other words, when projected orthogonally onto one of its large surfaces), are located completely within a defined region projected onto the large surface. The light guide further includes at least one end lighting component located or arranged at an end of the row of lighting components, wherein the narrow side of the light guide closest to the end lighting component has at least one straight section at the end of the row, and wherein the end lighting component is aligned on the coupling-in side such that the center of an emission surface of the end lighting component is disposed at a distance p/2, with an alignment tolerance of at most ±0.3·p, from an intersection point of the projection of the longest straight section or part of an imaginary extension thereof of the narrow side of the light guide closest to the end lighting component (i.e., the closest narrow side that is not the coupling-in side) with the coupling-in side at the end of the row, wherein the distance p/2 is measured along the direction of the longest extension of the coupling-in side, whereby a part of the light emitted by the end lighting component into the light guide is totally reflected therein. As a result, for at least half of an area of the defined region of the light guide (preferably for three quarters or the entire area of the region), the luminance uniformity (depending on the color of the light of the lighting components, one or more colors are considered with respect to their respective luminance uniformity; in particular, this may relate to white luminance uniformity) of the light coupled out from at least one of the large surfaces of the light guide, measured at three angles differing from one another by at least 20° and lying in a plane containing the central normal to the corresponding large surface of the light guide, is in each case greater than 50%.

Advantageously, the light guide is at least 50% transparent to light penetrating it over its large-area extent. For example, the lighting components may be LEDs (preferred), LED arrays, or laser diodes, whose emission surface is preferably at least approximately rectangular. Other variants are conceivable and fall within the scope of the present disclosure.

The term “intersection point S” explicitly includes not only the case in which two straight lines or line segments intersect, but also the case in which two straight lines or line segments merely touch each other. Such a point of contact then corresponds to the intersection point S within the meaning of the present disclosure. If the coupling-in side is not entirely straight, the longest straight portion thereof is considered, for the purpose of determining the aforementioned intersection point S, to conceptually define the corresponding straight line.

In other embodiments, the light guide has the defined region B with (substantially) a rectangular shape, and a distance from at least one edge of the defined region B to the narrow side of the light guide, which does not correspond to the coupling-in side, is equal to p/2 with a distance tolerance of at most ±0.3·p. It is possible that the defined region B deviates from a rectangular shape because the entire boundary of the defined region B is often not occupied by coupling-out elements. As a simplification, the narrowest rectangle encompassing all coupling-out elements may generally be regarded as the defined region B.

Preferably, all of the aforementioned tolerances (specifically, both distance tolerances and alignment tolerances)±0.3·p are to be constructed strictly, namely ±0.2·p or even ±0.1·p. The present disclosure achieves particularly favorable results when a lighting component located at an end of the row of lighting components is aligned at the coupling-in side such that its surface center point is positioned at a distance of p/2, with a tolerance of at most ±0.1·p, from the intersection point S of the projection of an imaginary extension of the longest straight portion of the narrow side nearest to the lighting component with the coupling-in side at the end of the row of lighting components, wherein the distance p/2 is measured along the direction of the longest extent of the coupling-in side. Preferably, the relationships apply at both ends of the row of lighting components.

The coupling-out elements for coupling out light at least at one of the large-area surfaces of the light guide may generally include microlenses and/or microprisms and/or micro-prismatoids and/or diffraction structures and/or meta-structures and/or three-dimensional structural elements having a maximum extent in their largest dimension that is less than 100 micrometers, preferably less than 50 micrometers. In the case of diffraction structures, for example, these may be a hologram or a grating/diffraction grating. Preferably, however, the coupling-out elements including at least one curved functional surface have the form of three-dimensional structural elements.

It is essential to the implementation of the present disclosure that the targeted coupling-out of light from the light guide does not occur by scattering, as is customary in most commercially available light guides. The present disclosure would be ineffective if coupling-out were achieved by scattering elements known in the prior art that effectively disrupt or “damage” the light guide surface, since in such a case the coupling-out would not be defined or deterministic but primarily diffuse. Furthermore, coupling-out by means of scattering elements would have an adverse consequence that the light guide would strongly scatter light passing through it via its large surfaces, which constitutes an exclusion criterion particularly for its use in privacy applications. Thus, it can be concluded that, in the present disclosure, the primary approach of the light guide to coupling-out does not rely on the principle of scattering. For this reason, (micro-) prismatoids, three-dimensional structural elements, diffraction structures, or microlenses are particularly preferred, as these enable deterministic coupling-out of light, apart from unavoidable scattering within a predetermined tolerance. In general, scattering of light passing through the light guide should be kept as low as possible, as described in the following two sections.

The coupling-out elements are selected according to their number per unit area and their extent such that the light guide exhibits an average haze value of less than 20%, preferably less than 15%, more preferably less than 10%, over at least 50%, preferably 80%, and most preferably the entire area of its surface, as measured according to ASTM D1003, wherein the measurement is based on the more commonly used Procedure A with a hazemeter as reference. As a result, light passing through the large surfaces of the light guide is scattered to only a minor extent. For example, the term “minor extent” means that (due to the low haze value) within an angular range of, for instance, horizontally ±40° from the surface normal, at most 1% to 5% of luminance is added by scattering of light injected perpendicularly through a large surface into the light guide. Commercially available light guides that rely on scattering as the primary mechanism for coupling-out typically do not achieve the aforementioned haze values.

Alternatively, it is possible that the coupling-out elements are selected according to their number per unit area and their extent such that the light guide scatters, over at least 80% of the defined region B (preferably over the entire defined region B), no more than 25%, and preferably no more than 10%, of the light passing through its large-area surfaces by more than 10° (preferably only by 7°, and preferably merely by) 5°. Commercially available light guides utilizing scattering as the primary mechanism for coupling-out typically do not achieve the aforementioned maximum scattering values.

The coupling-out elements themselves may also individually have an external shape of microlenses, microprisms, micro-prismatoids, three-dimensional structural elements, and/or diffractive structures. For example, they may be configured as cavities formed within the volume of the light guide. The cavities may be evacuated, but are preferably filled with a gaseous, liquid, or solid material. The material has a refractive index that differs from that of the material used for the light guide; preferably, it is lower. By filling the cavities with a material and by selecting the material, influence can be exerted on light guiding and/or coupling-out. Alternatively or additionally, the haze value of the material preferably differs from that of the material used for the light guide and is preferably higher. The advantages of these configurations include higher efficiency in coupling-out.

Alternatively and in a technically simpler manner, the cavities may also be formed by constructing the light guide from two substrate layers connected to each other, wherein the substrate layers are preferably of the same type. The connection may be effected chemically, physically, or by adhesive bonding. The cavities are then configured as material recesses at at least one of the interfaces of the substrate layers.

When the coupling-out elements are arranged on or formed on at least one of the large surfaces of the light guide, they are advantageously formed from a plastic or glass material structured by a tool, wherein the structure has been imprinted by means of the tool. This is possible, for example, in mass production by applying a UV-curable material (such as a lacquer, a monomer, etc.) onto a substrate of the light guide, structuring the material by means of a tool, and curing it by UV radiation, e.g., by polymerization. Other radiation-curable materials may also be employed. The formation of recesses for realizing the coupling-out elements can be implemented, for example, by mechanical, lithographic, or printing techniques, or alternatively by material-additive, material-transforming, material-removing, or material-dissolving methods. In particular, variants of injection molding (variothermal/isothermal, injection compression molding/injection molding) may be employed using appropriate structured inserts (see also DE 1020 201 340 55 B4 of the applicant).

Thus, for example, grating structures, microprisms/mircoprismatoids, or three-dimensional structural elements (either convex with a plastic portion protruding outward from the surface, and/or concave as an embossing or recess within the surface layer of the structured plastic) as well as other three-dimensional structural elements having different shapes, or even microlenses, can be implemented cost-effectively and in a manner suitable for mass production. Concave and convex structures can be employed equally.

The structure of the coupling-out elements is predefined according to the aforementioned criteria, wherein the effect of each coupling-out element is at least approximately known, and properties of the light guide or of the light coupled out form the light guide can be specifically determined by a predefined structure and distribution of the coupling-out elements, wherein it is particularly important to consider a ratio of a sum of areas of the functional surfaces to an area of the total large surface from which light is coupled out.

The required properties essential to the present disclosure for the coupling-out elements (regarding their number per unit area, their shape, their orientation and three-dimensional extent, as well as their distribution on at least one of the large-area surfaces and/or within the volume of the light guide) can be determined, for example, using optical simulation software such as “LightTools” from Synopsys or from other vendors, and then physically implemented accordingly.

Advantageously, the distribution of the coupling-out elements on at least one of the large surfaces and/or within the volume of the light guide is predetermined such that the coupled-out light achieves a luminance uniformity (in particular with respect to white light) of at least 50%, preferably at least 60%, over at least 50% (preferably 95% or 100%) of the entire defined region B of the light guide. The luminance uniformity may be defined herein as Lᵥ^{min}/Lᵥ^{max}, i.e., as the ratio of the smallest luminance value to the largest luminance value over an area under consideration (so-called “area scan” approach, in which every measured value across the considered area is included in the evaluation). Within the scope of the present disclosure, this shall apply for three angles lying in a plane containing the central normal to the respective large surface of the light guide, wherein the angles differ from one another by at least 20°, for example −20°, 0° and +20°, or 0°, +20° and +45°, or 0°, −20° and −45°, or also −45°, 0° and +45°, wherein preferably the plane is oriented horizontally from the perspective of an observer.

The means-effect relationships of the present disclosure include, among others, that, due to the end lighting component positioned at the end of the corresponding row of lighting components as selected according to the present disclosure, and thus inherently also due to the all existing lighting components positioned relative to the geometry of the chosen coupling-in side, at least a (partial) effect of an additional, physically non-existent lighting component located outside the row of lighting components is generated. This is achieved by total internal reflection of a portion of the light emitted by the end lighting component, i.e., the last lighting component at the end of the row of lighting components, at that narrow side which is closest to the end lighting component and which directly adjoins the coupling-in side in the immediate vicinity of the end lighting component of the row of lighting components. As a result, a combination of light rays is produced within the light guide that closely approximates the situation in which an additional (imaginary) lighting component were present beyond the end lighting component (i.e., beyond the last lighting component at the end of the row of lighting components) at approximately the center-to-center distance p. For coupling-out by the coupling-out elements in region B, this in turn means that sufficient light is available to achieve good luminance uniformity of the coupled-out light over a wide angular range; that is, the luminance uniformity remains relatively stable when viewed from different observation angles differing, for example, by at least 20°.

If, otherwise, the area centroid of the end lighting component is not arranged at a distance of p/2 with a tolerance of at most ±0.3·p from the aforementioned intersection point S (e.g., at a distance greater than 0.6·p from the aforementioned intersection point S), the desired luminance uniformity values of at least 50% generally cannot be achieved, since pronounced luminance variations particularly occur at corners near the coupling-in side at an angle greater than or equal to ±25° or greater than or equal to ±45°. These variations in turn arise particularly because, due to the positioning of the end lighting component, which in this case is not selected according to the present disclosure, there is no effect equivalent to that of an additional, physically non-existent lighting component located beyond the row of lighting components, wherein a portion of the light emitted by the end lighting component would be totally reflected at the narrow side closest to this end lighting component, which narrow side adjoins the coupling-in side directly adjacent to the aforementioned last lighting component of the aforementioned row of lighting components.

A suitable range for the distance between the lighting components and the coupling-in side of the light guide is from 200 μm to 700 μm, with a sub-range of approximately 400 μm to 550 μm being preferred. This range also depends on the thickness of the light guide. Thicker light guides generally allow somewhat a larger distance than those mentioned above. Overall, other distances are also conceivable within the scope of the present disclosure.

The average center-to-center distance p of the lighting components is commonly in the range of 3 mm to approximately 8 mm. However, other values are explicitly possible. Preferably, this center-to-center distance p is in the range of 5 mm to 6.5 mm.

In another aspect, the object of the present disclosure is solved by a lighting apparatus for a screen adapted to operate in at least two operation modes, including a first operation mode B1 for a free view mode and a second operation mode B2 for a limited view mode, in which light is emitted by the lighting apparatus within a viewing angle range that is restricted compared to the free view mode. The lighting apparatus includes a planar backlight and configured to emit light into the limited viewing angle range, and the plate-shaped light guide as described above disposed in front of the backlight in the viewing direction, the light guide having lighting components arranged at a narrow side serving as a coupling-in side. In the second operation mode B2, the backlight is turned on and the lighting components are turned off, and in the first operation mode B1, at least the lighting components are turned on.

Advantageously, the light guide may be configured such that it exhibits a stronger scattering property in a selectable direction than in a direction perpendicular thereto. This selectable direction may correspond to a vertical direction when an observer views the lighting apparatus, so that the scattering property of the light guide is greater in the vertical direction than in a horizontal direction, wherein the horizontal direction is parallel to a line between eyes of the observer.

Furthermore, it is possible to attenuate optical artifacts that may occur, for example, due to the manufacturing of the light guide or its coupling-out structures, by means of an anisotropic diffuser. According to the previously described definition of directions, this diffuser should scatter light significantly less in the horizontal direction than in the vertical direction, so that in the second operation mode B2 for a limited view mode, light is scattered horizontally only minimally or, ideally, not at all.

Furthermore, the present disclosure may be implemented such that the defined region B is divided into sub-regions of a predetermined size, and a ratio of the (cumulative) areas of the functional surfaces within a sub-region to the area of the sub-region differs among different sub-regions, so that the scattering property of the light guide varies across the defined region B. It should be noted that the large surface from which the light exits does not necessarily correspond to the large surface on which the coupling-out elements are located. Rather, for example, the latter large surface may include (micro-) prismatoids or three-dimensional structural elements directed toward the volume of the light guide, each having at least one straight or curved functional surface, which redirect and thereby couple out the coupled-in light; however, the coupled-out light rays still traverse the volume of the light guide or portions thereof before exiting the light guide through the aforementioned other large surface.

In principle, any angular range smaller than the half-space in front of the backlight may be considered as the limited angular range. Preferably, for example, an angular range of ±20° or =30° horizontally and/or vertically, or a conical range about the surface normal or a selectable direction vector on the backlight is intended; small amounts of light of less than 1% to 5% of the maximum brightness may be disregarded in defining the limited angular range. The lighting apparatus may further include a collimation film at a suitable location in the structure, for example, a lens or prism array above or below the plate-shaped light guide.

The coupling-out elements may, during the manufacture of the light guide, be distributed in or on the light guide in various ways according to adaptable and predefined conditions for coupling-out. The coupling-out elements are locally confined structural modifications within the volume and/or on the surfaces of the light guide. Additional optical layers applied to the surfaces of the light guide, such as diffusion layers, reflection layers, (dual) brightness enhancement films (BEFs) for collimation or brightness enhancement, or polarization-recycling layers, for example polarization-selective Bragg reflectors ((dual) brightness enhancement films, (D)BEFs) or wire-grid polarizers, are expressly excluded from the term “coupling-out element.” These additional layers, which do not fall under the definition of a “coupling-out element,” are, if used at all, connected to the light guide only at the edges and typically rest loosely over the large-area regions without forming a physical unit with the light guide. In contrast, coatings applied to the large-area surfaces that bond with the light guide through chemical reactions or other forces (e.g., van der Waals forces) form a physical unit and cannot be separated from the light guide; such coatings therefore do not constitute an additional layer in the aforementioned sense.

Two operation modes B1 and B2 differ in that, in the second operation mode B2, the backlight is turned on and the lighting components (at the coupling-in side of the light guide) are turned off, whereas in operation mode B1, at least the lighting components (at the coupling-in side of the light guide) are turned on. Only light that was originally emitted by the lighting components into the light guide and subsequently coupled out from the light guide via the coupling-out elements is taken into account, wherein the emission occurs almost exclusively via the coupling-out elements.

It is possible that the coupling-out elements are provided on both large-area surfaces and/or additionally optionally within the volume.

Preferably, the light guide consists of a transparent thermoplastic or thermoelastic polymer, for example plastic, or glass. For instance, the light guide or its substrate may include at least 40 percent by weight of polymethyl methacrylate, preferably at least 60 percent by weight of polymethyl methacrylate, based on its total weight. Alternatively, it may be, for example, polycarbonate (PC).

Furthermore, for certain applications it is advantageous that the aforementioned limited angular range is asymmetrically formed about the surface normal of the backlight. The asymmetrical configuration is preferably implemented in a direction predetermined according to the application. This is particularly beneficial in automotive applications, for example when a screen combined with the lighting apparatus according to the present disclosure is arranged as a so-called center information display in a dashboard approximately midway between a driver and a front passenger. In such a case, the limited angular range exclusively enabled for the front passenger in operation mode B2 must be asymmetrically shaped, i.e., directed toward the front passenger. The predetermined direction in which the asymmetry is formed corresponds here to the horizontal direction.

The backlight includes, for example, an area light source, preferably another light guide with additional lighting components arranged laterally or on the rear side, as well as at least one light collimator integrated into the area light source and/or disposed in front thereof, such as at least one prism film and/or at least one privacy filter (louver filter). Alternatively, instead of a louver filter, an optical element including absorption dipole moments may be employed, wherein a majority of the absorption dipole moments are aligned perpendicular to the surface normal of the optical element with a tolerance of at most 20°, in order to restrict the direction of light. Furthermore, a so-called focused backlight unit may be used as the backlight, in which light is coupled out from a (different) light guide already within a limited angular range and, if necessary, further directed, deflected, or reshaped.

Accordingly, the backlight may generally be configured like an LED backlight, for example as a so-called direct-lit LED backlight, an edge-lit LED backlight, an OLED, or another area emitter, onto which at least one permanent privacy filter (e.g., with microlouvers or polarization-sensitive) is applied.

For all of the aforementioned variants of the lighting apparatus, it is particularly advantageous if the apparatus further includes a transmissive screen arranged in front of the lighting apparatus in the viewing direction, preferably in the form of an LCD panel, which can be operated in at least two operation modes B1 for a free view mode and B2 for a limited view mode by virtue of the lighting apparatus.

The lighting apparatus according to the present disclosure is particularly advantageously used in combination with a screen in a vehicle for selectively displaying image content either exclusively to the passenger in the second operation mode B2 or simultaneously to both the driver and the passenger in the first operation mode B1. The former is, for example, helpful when the passenger views entertainment content that could distract the driver.

According to the present disclosure, the lighting apparatus with a screen can likewise be used for inputting or displaying confidential data, for example PINs, emails, SMS messages, or passwords, at automated teller machines, payment terminals, or mobile devices.

Furthermore, the desired limited angular ranges for the second operation mode B2 for limited viewing can be defined and implemented independently for the horizontal and vertical directions, respectively. For example, in the vertical direction, a larger angle (or possibly no restriction at all) may be advantageous compared to the horizontal direction, such as in the case of automated teller machines where persons of different heights should be able to view the image, while lateral viewing is to be strongly or completely restricted. In contrast, for point-of-sale (POS) payment terminals, viewing limitations in the second operation mode B2 are often required in both the horizontal and vertical directions due to security regulations.

In principle, the functionality of the present disclosure is essentially maintained if the described parameters are varied within certain limits.

It is understood that the features mentioned above and those described hereinafter may be used not only in the specified combinations, but also in other combinations or in isolation, without departing from the scope of the present disclosure.

### BRIEF DESCRIPTION OF THE DRAWINGS

The present disclosure will be described in more detail below according to exemplary embodiments with reference to accompanying drawings, which disclose features essential for the present disclosure. These exemplary embodiments are for illustration purposes only and are not to be interpreted as limiting. For example, a description of an exemplary embodiment with a plurality of elements or components is not to be interpreted to be all of these elements or components necessary for the implementation. In contrast, other exemplary embodiments can also include alternative elements and components, fewer elements or components, or additional elements or components. Elements or components of different exemplary embodiments can be combined with one another, unless otherwise stated. Modifications and variations, which are described for one of the exemplary embodiments, can also be applied to other exemplary embodiments. To avoid repetitions, identical or corresponding elements in different figures are identified with identical reference numerals and are not described repeatedly, in which:

FIG. 1 shows a schematic diagram of a light guide with lighting components;

FIGS. 2A to 2C show further schematic diagrams (in partial view) of a light guide with lighting components, illustrating various distances;

FIGS. 3A to 3D show simulation results for a luminance distribution of a light guide section, depicted from different viewing angles, for a first position of the lighting components;

FIGS. 4A to 4D show simulation results for a luminance distribution of a light guide section, depicted from different viewing angles, for a second position of the lighting components;

FIGS. 5A to 5D show simulation results for a luminance distribution of a light guide section, depicted from different viewing angles, for a third position of the lighting components;

FIG. 6 shows a graph providing an overview of various simulation results; and

FIG. 7 shows a schematic diagram of a lighting apparatus with a screen.

### DETAILED DESCRIPTION

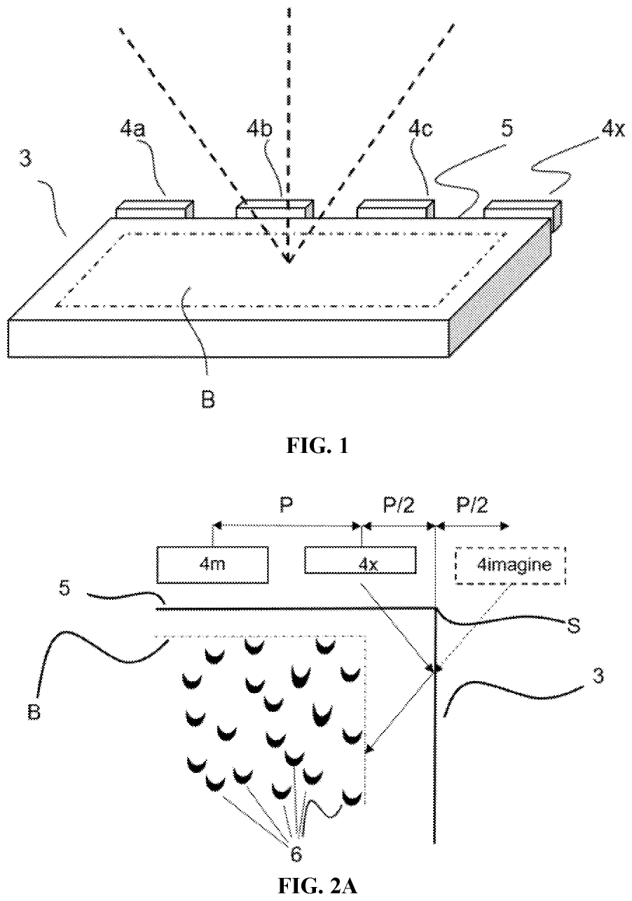

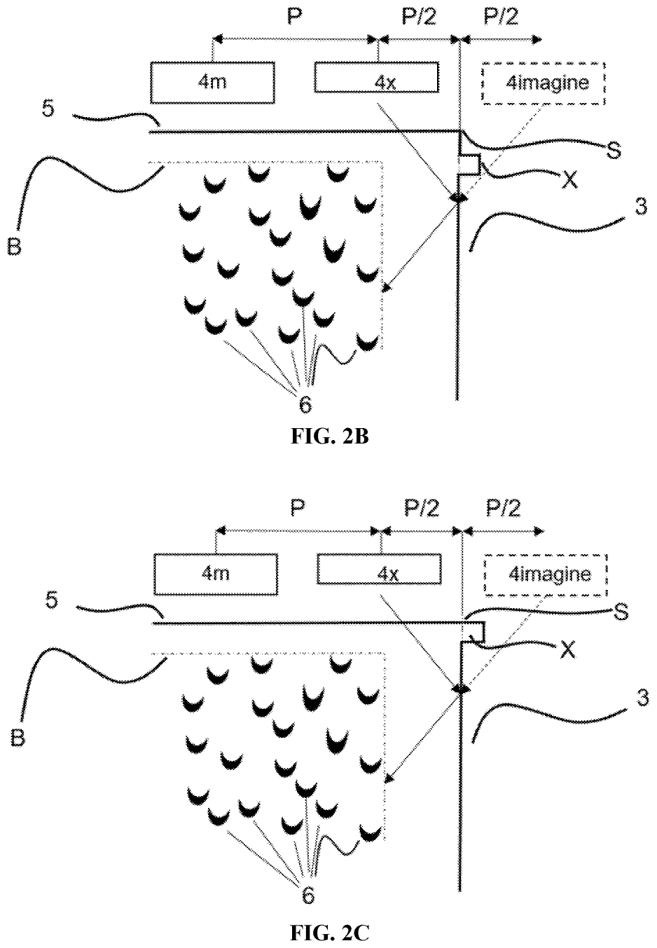

FIG. 1 shows a schematic diagram of a plate-shaped light guide 3 with lighting components 4a, 4b, . . . and FIGS. 2A to 2C show further schematic diagrams of a light guide 3 with lighting components 4a, 4b, . . . in a top view of a section (upper right corner from the perspective of an observer), illustrating various distances.

The light guide is a plate-shaped light guide 3 having two large surfaces and narrow sides connecting the large surfaces at their edges. The light guide 3 includes a plurality of individual lighting components 4a, 4b, . . . arranged in a row (FIG. 1 shows by way of example four lighting components 4a, 4b, 4c, and 4x, although in a practical embodiment considerably more, on the order of several dozen or more, may be present). One of the narrow sides of the light guide 3 serves as a coupling-in side 5 for light from the lighting components 4a, 4b, . . . , wherein the lighting components 4a, 4b, . . . have an average center-to-center distance of p and emission surfaces. The light guide 3 further has coupling-out elements 6 on at least one of the large surfaces and/or within its volume (in FIG. 2A this is only indicated schematically; in reality considerably more coupling-out elements 6 are present, and they are also significantly smaller relative to the lighting components 4a, 4b, . . . ). Each coupling-out element 6 has at least one functional surface (not shown in the drawings) for defined coupling-out of light from the light guide, i.e., light is coupled out from the light guide 3 at the functional surface. All coupling-out elements 6, when the light guide 3 is viewed in a direction toward one of its large surfaces, or, in other words, when projected orthogonally onto one of its large surfaces, lie completely within a defined region B projected onto the large surface. The light guide 3 further includes at least one end lighting component 4x located at an end of the row of lighting components 4a, 4b, . . . , wherein the narrow side closest to the end lighting component 4x at the end of the row has at least one straight section, and wherein the end lighting component is aligned on the coupling-in side 5 such that the area centroid of its emission surface is disposed at a distance p/2, with an alignment tolerance of at most ±0.3·p, from an intersection point S of the projection of an imaginary extension of the longest straight section of the narrow side closest to the end lighting component 4x at the end of the row of lighting components 4a, 4b, . . . with the coupling-in side 5, wherein the distance p/2 is measured along the direction of the longest extension of the coupling-in side 5, as shown in detail in FIG. 2A, whereby a part of the light radiated by the end lighting component 4x into the light guide 3 is totally reflected therein. As a result, for at least half of an area of the defined region B of the light guide 3 (preferably for three quarters or the entire area of the region B), the luminance uniformity (depending on the color of the light of the lighting components 4a, 4b, . . . , one or more colors are considered with respect to their respective luminance uniformity; in particular, this may relate to white luminance uniformity) of the light coupled out from at least one of the large surfaces, measured at three angles differing from one another by at least 20° and lying in a plane containing the central normal to the corresponding large surface of the light guide 3 (see the dashed thick lines in FIG. 1 indicating such exemplary angles), is in each case greater than 50%.

The term “intersection point S” is explicitly intended to encompass not only the case in which two straight lines or line segments intersect, but also the case in which they merely touch each other, in which case the point of tangency constitutes the intersection point S within the meaning of the present disclosure.

FIG. 2B shows a further schematic diagram of a section of a light guide 3 with lighting components 4a, 4b, . . . , illustrating various distances. The explanations given with respect to FIG. 2A apply analogously. Here too, the end lighting component 4x located at an end of the row of lighting components 4a, 4b, . . . is aligned on the coupling-in side 5 such that the area centroid of its emission surface is disposed at a distance p/2, with an alignment tolerance of at most ±0.3·p, from the intersection point S of the projection of an imaginary extension of the longest straight part of the narrow side closest to the end lighting component 4x at the end of the row of lighting components 4a, 4b, . . . with the coupling-in side 5, wherein the distance p/2 is measured along the direction of the longest extension of the coupling-in side 5. However, the light guide 3 in this case has a so-called stopper X, corresponding to a protrusion on the right narrow side. Stoppers of this kind are applied in the prior art to anchor light guides in a backlight assembly. Such stoppers may in principle take any shape and do not necessarily have straight edges. At this point it becomes clear why the intersection point S was defined as described above: the imaginary extension of the longest straight part of the narrow side closest to the end lighting component 4x at the end of the row of lighting components 4a, 4b, . . . (i.e., here the right side) is not affected by the stopper X; rather, the imaginary extension (represented here by the dash-dot line) intersects or touches the coupling-in side 5 at the same intersection point S as in the arrangement of FIG. 2A.

FIG. 2C likewise shows a schematic diagram of a section of the light guide 3 with lighting components 4a, 4b, . . . , again illustrating various distances. The explanations given with respect to FIGS. 2A and 2B apply in analogous form. In this case, however, the stopper X is located directly at the end of the coupling-in side 5. Based on the definition of the intersection point S given above, the intersection point S is also unambiguously determined under the conditions of FIG. 2C.

It goes without saying that one or more stoppers X may also be present at other and/or multiple positions and/or on multiple narrow sides. Furthermore, a stopper may also constitute a recess in a narrow side.

The lighting components 4a, 4b, . . . are preferably LEDs, whose emission surface is at least approximately rectangular. Other variants are conceivable and fall within the scope of the present disclosure.

Further embodiments provide for the defined region B of the light guide 3 to have (substantially) a rectangular shape, as shown in FIG. 1.

Preferably, all of the aforementioned and hereinafter mentioned tolerances, alignment tolerances, and distance tolerances of ±0.3·p are to be construed strictly, namely as ±0.2·p or even ±0.1·p. The present disclosure achieves particularly favorable results when the lighting component 4x located at an end of the row of lighting components 4a, 4b, . . . is aligned on the coupling-in side 5 such that its area centroid is disposed at a distance of p/2, with a tolerance of at most ±0.1·p, from the aforementioned intersection point S, measured along the direction of the longest extension of the coupling-in side 5.

The configuration according to the present disclosure is preferably applied simultaneously to both ends of the row of lighting components 4a, 4b, . . . , i.e., to the first lighting component 4a, which is then configured as a start lighting component, and to the end lighting component 4x of the row of lighting components 4a, 4b, . . . .

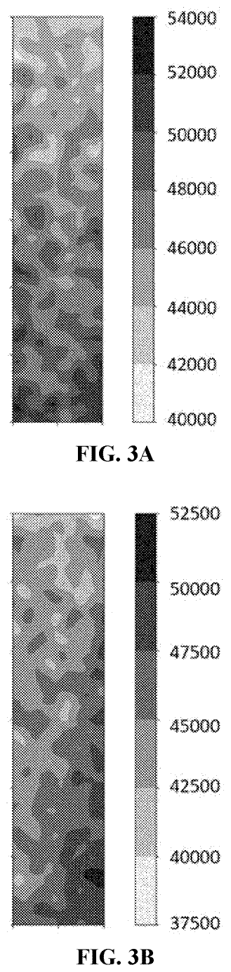

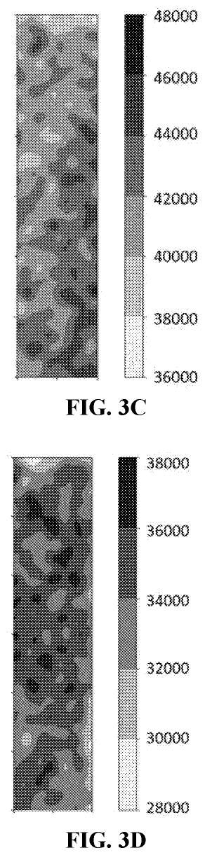

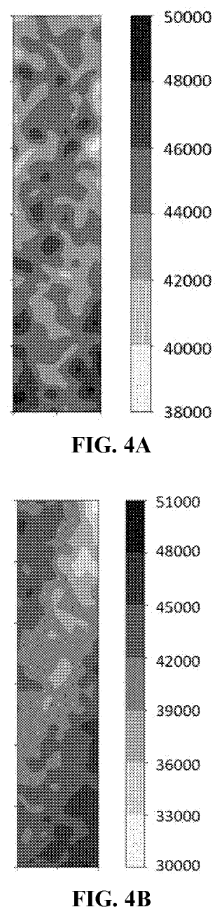

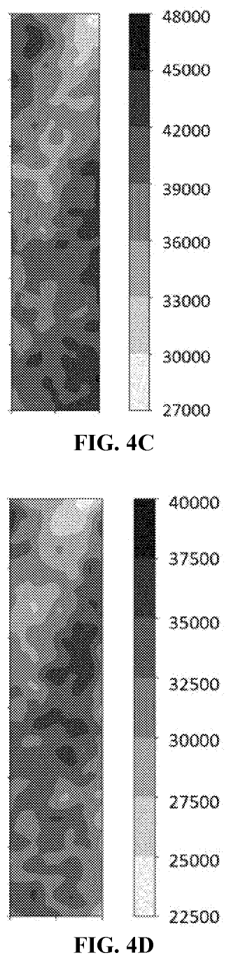

The coupling-out elements 6 may advantageously have the form of (micro-) prismatoids. Preferably, however, the coupling-out elements 6 have the form of three-dimensional structural elements that include at least one curved functional surface. Examples of three-dimensional structural elements including at least one curved functional surface are described, among others, in WO 2023/274541 A1 (e.g., FIGS. 3 and 4, or others) and in US 2018/088270 A1 (e.g., FIGS. 3A to 3D, 4B, and 5A, or others).

When the coupling-out elements 6 are arranged on at least one of the large surfaces of the light guide 3, they are advantageously formed from a plastic or glass material structured by a tool, wherein the structure has been imprinted by means of the tool. This is possible, for example, in mass production by applying a UV-curable material (such as a lacquer, a monomer, etc.) onto a substrate of the light guide, structuring the material by means of a tool, and curing it by UV radiation, e.g., by polymerization.

Advantageously, the distribution of the coupling-out elements 6 on at least one of the large surfaces and/or within the volume of the light guide (but within region B) is predetermined such that the coupled-out light achieves a luminance uniformity (in particular with respect to white light) of at least 60% over at least 50% (preferably 95% or 100%) of the entire defined region B of the light guide. The luminance uniformity may be defined herein as Lᵥ^{min}/Lᵥ^{max}, i.e., as the ratio of the smallest luminance value to the largest luminance value over an area under consideration. Within the scope of the present disclosure, this shall apply for three angles lying in a plane containing the central normal to the corresponding large surface of the light guide 3, wherein the angles differ from one another by at least 20°, for example −20°, 0°, and +20°, or 0°, +20°, and +45°, or 0°, −20°, and −45°, or also −45°, 0°, and +45°, wherein preferably the plane is horizontal from the perspective of an observer.

The coupling-out elements 6 are further selected according to their number per unit area and their extent such that the light guide 3 exhibits an average haze value of less than 20%, preferably less than 15%, more preferably less than 10%, over at least 50%, preferably 80%, of the defined region B, and most preferably over its entire area, as measured according to ASTM D1003, wherein the measurement is based on the more commonly used Procedure A with a hazemeter as reference. As a result, light passing through the large surfaces or through the defined region B of the light guide 3 is scattered to only a minor extent. For example, the term “minor extent” means that (due to the low haze value) within an angular range of, for instance, horizontally ±40° from the surface normal, at most 1% to 5% of luminance is added by scattering of the light guide 3 to light injected at normal incidence) (0° through a large surface into the light guide 3.

Alternatively, it is possible that the coupling-out elements 6 are selected according to their number per unit area and their extent such that the light guide 3 scatters, over at least 80% of the defined region B (preferably over the entire defined region B), no more than 25%, and preferably no more than 10%, of the light passing through its large surfaces by more than 10°(preferably only by 7°, and preferably merely by) 5°.

The means-effect relationships of the present disclosure include, among others, that, as illustrated in particular in FIGS. 2A to 2C, due to the end lighting component 4x positioned at the end of the corresponding row of lighting components 4a, 4b, . . . as selected according to the present disclosure, at least a (partial) effect of an additional, physically non-existent, quasi-“assumed” imaginary lighting component 4imagine located outside the row of lighting components 4a, 4b, . . . is generated. This is achieved by total internal reflection of a portion of the light emitted by the end lighting component 4x at the end of the row of lighting components 4a, 4b, . . . at that narrow side which is closest to the end lighting component and which directly adjoins the coupling-in side in the immediate vicinity of the end lighting component 4x of the row (see the indicated light ray from lighting component 4a shown as a solid line directed toward the right narrow side of the light guide 3). Furthermore, FIG. 2A indicates by a dashed line an exemplary light ray that would originate from the assumed imaginary lighting component 4imagine and travel toward the right narrow side of the light guide. In reality, however, only a conceptual continuation of such a ray exists within the light guide 3, arising from the totally reflected light of the end lighting component 4x as described above, thereby producing a combination of light rays within the light guide 3 that closely approximates what would exist if an additional imaginary lighting component 4imagine followed the end lighting component 4x at the end of the row of lighting components 4a, 4b, . . . . For coupling-out by the coupling-out elements 6 in the region B, this in turn means that sufficient light is available to achieve good luminance uniformity of the coupled-out light over a wide angular range.

If, otherwise, the area centroid of the end lighting component 4x is not disposed at a distance of p/2 with a tolerance of at most ±0.3·p from the aforementioned intersection point S (e.g., at a distance greater than 0.9·p from the aforementioned intersection point S), the desired luminance uniformity values of at least 50% generally cannot be achieved, since pronounced luminance variations occur particularly at the corners near the coupling-in side at an angle greater than ±20° or greater than ±45°. These variations arise particularly because, due to the positioning of the end lighting component 4x that is not selected in accordance with the present disclosure, there is no effect equivalent to that of an additional, physically non-existent imaginary lighting component 4imagine (see FIG. 2A) located outside the row of lighting components 4a, 4b, . . . , wherein a portion of the light emitted by the end lighting component 4x would be totally reflected at the narrow side closest to this end lighting component 4x, which narrow side adjoins the coupling-in side directly adjacent to the aforementioned last lighting component of the row.

All drawings from FIG. 3A through FIG. 5D depict a (simulated) luminance distribution of a light guide section, more specifically a sector of the defined region B of the light guide 3. Adjacent to the right of each drawing, a legend of grayscale values for simulated luminance levels in units of cd/m² is shown. This sector of the defined region B is located near the end lighting component 4x at the end of the corresponding row of lighting components 4a, 4b, . . . and its right edge simultaneously represents the right end of the defined region B, or a portion thereof. Each sector simulates an approximately 15 mm wide and approximately 68 mm high area of the defined region B of the light guide 3. Furthermore, FIGS. 3A, 4A, and 5A each show the corresponding luminance distribution for an angle H0°V0°; FIGS. 3B, 4B, and 5B each show the corresponding distribution for H−20° V0°; FIGS. 3C, 4C, and 5C each show the corresponding distribution for H−30° V0°; and FIGS. 3D, 4D, and 5D each show the corresponding distribution for H−45° V0°. All of the aforementioned angles satisfy the condition of lying in a plane containing the central normal to the corresponding large surface of the light guide 3.

Additional parameters for all results shown in FIGS. 3A to 6 are as follows: (a) distance from the lighting components 4a, 4b, . . . to the coupling-in side 5 of the light guide 3: 500 μm; (b) thickness of the light guide: 2 mm; (c) average center-to-center distance p of the lighting components 4a, 4b, . . . : 5 mm; (d) size of the coupling-out elements 6 having three-dimensional structure: maximum dimensions between 3 μm and 30 μm.

FIGS. 3A to 3D show simulation results for the luminance distribution of a light guide section, depicted from various viewing angles, for a first position of the lighting components. In this first position, the end lighting component 4x located at the end of the row of lighting components 4a, 4b, . . . is aligned on the coupling-in side 5 such that its area centroid is disposed (exactly) at a distance p/2 from the intersection point S (as defined above) with the coupling-in side 5, measured along the direction of the longest extension of the coupling-in side 5. The simulated luminance uniformity values are as follows:

| Angle | H0°V0° | H−20°V0° | H−30°V0° | H−45°V0° |
|---|---|---|---|---|
| Simulated luminance | 77.5% | 74.2% | 77.8% | 74.3% |
| uniformity | | | | |

It can be seen that the luminance uniformity is very stable and consistently greater than 50%, even over larger viewing angles up to H−45° V0°. This is achieved by virtue of the means-effect relationships of the present disclosure described above.

FIGS. 4A to 4D show simulation results for the luminance distribution of a light guide section, depicted from various viewing angles, for a second position of the lighting components. In this second position, the end lighting component 4x located at the end of the row of lighting components 4a, 4b, . . . is aligned on the coupling-in side 5 such that its area centroid is disposed at a distance p/2+0.2·p from the intersection point S (as defined above) with the coupling-in side 5, measured along the direction of the longest extension of the coupling-in side 5. It can be seen in particular from FIGS. 4C and 4D that the minimum luminance values occur primarily at the upper right edge. These may, however, still be acceptable. The simulated luminance uniformity values are as follows:

| Angle | H0°V0° | H−20°V0° | H−30°V0° | H−45°V0° |
|---|---|---|---|---|
| Simulated luminance | 78.9% | 66.3% | 62.4% | 61.7% |
| uniformity | | | | |

It can be seen that the luminance uniformity is still largely stable, even over larger viewing angles up to H−45° V0°. All luminance uniformity values, even under steep oblique viewing at H−45° V0°, are as desired greater than 50%, here even greater than 60%. This is achieved by virtue of the means-effect relationships of the present disclosure described above.

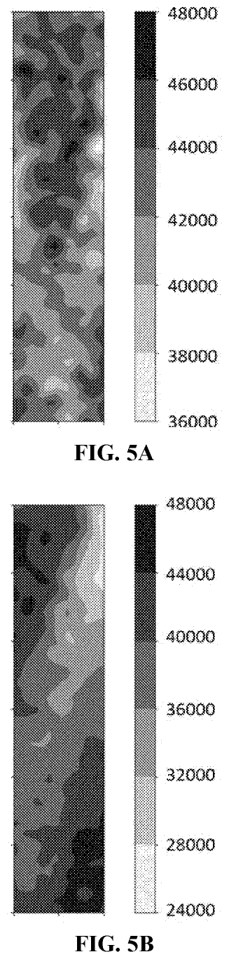

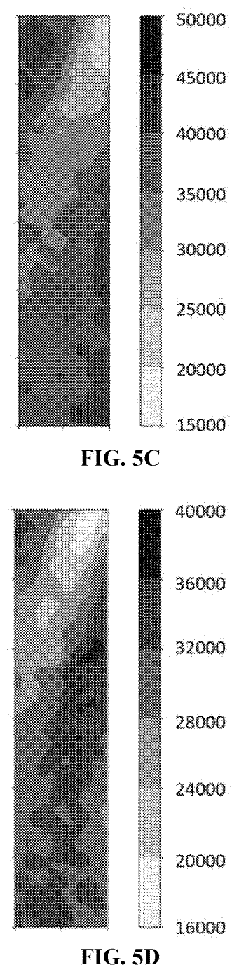

FIGS. 5A to 5D show simulation results for the luminance distribution of a light guide section, depicted from various viewing angles, for a third position of the lighting components. In this third position, the end lighting component 4x located at the end of the row of lighting components 4a, 4b, . . . is aligned on the coupling-in side 5 such that its area centroid is disposed at a distance p/2+0.4·p from the intersection point S (as defined above) with the coupling-in side 5, measured along the direction of the longest extension of the coupling-in side 5. It can be seen in particular from FIGS. 5B to 5D that the minimum luminance values occur primarily at the upper right edge. These have dropped to such a degree that a distinct shadow becomes visible in the corner when viewed from these angles, and the overall luminance uniformity is no longer acceptable. The simulated luminance uniformity values are as follows:

| Angle | H0°V0° | H−20°V0° | H−30°V0° | H−45°V0° |
|---|---|---|---|---|
| Simulated luminance | 77.8% | 55.8% | 42.7% | 46.2% |
| uniformity | | | | |

It can be seen that the luminance uniformity is not stable over larger viewing angle ranges. Luminance uniformity values below 60% or below 50% are not acceptable for various applications. These poor luminance uniformity values arise in particular because the means-effect relationships of the present disclosure described above are not realized in this case.

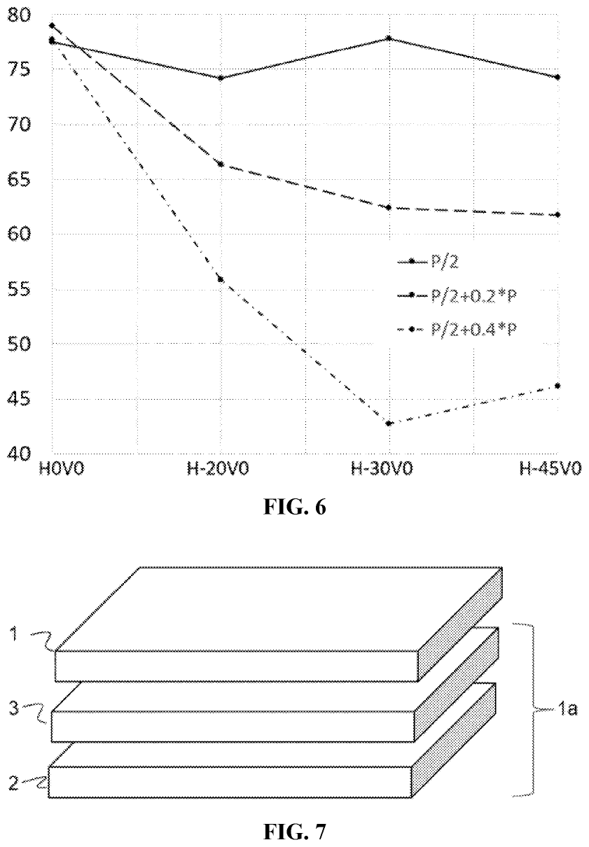

FIG. 6 shows a graph providing an overview of the aforementioned simulation results. It is clearly apparent that stable luminance distribution uniformity, even across different viewing angles, is achieved for the first and second positions of the end lighting component 4x in the row of lighting components 4a, 4b, . . . , whereas the third position, which explicitly falls outside the scope of the present disclosure, does not provide stable luminance distribution uniformity across different angles.

FIG. 7 shows a schematic diagram of a lighting apparatus 1a for a screen 1 adapted to operate in at least two operation modes, including a first operation mode B1 for a free view mode and a second operation mode B2 for a limited view mode, in which light from the lighting apparatus is emitted within a viewing angle range that is restricted compared to the free view mode. The lighting apparatus includes a planar backlight 2 configured to emit light into the limited viewing angle range, and the plate-shaped light guide 3 as described above disposed in front of the backlight 2 in the viewing direction, with lighting components 4a, 4b, . . . arranged on a narrow side serving as the coupling-in side 5, wherein the lighting components 4a, 4b, . . . are not shown in the drawing. In operation mode B2, the backlight 2 is turned on and the lighting components 4a, 4b, . . . are turned off, and in operation mode B1, at least the lighting components 4a, 4b, . . . are turned on.

In principle, any angular range smaller than the half-space in front of the backlight may be considered as the limited angular range. However, preferably, for example, an angular range of ±20° or ±30° horizontally and/or vertically, or a conical range about the surface normal or a selectable direction vector on the backlight, is intended; small amounts of light of less than 1% to 5% of the maximum brightness may be disregarded in defining the limited angular range.

The lighting apparatus 1a may further include a collimation film at a suitable location in the assembly, for example a lens or prism array above or below the plate-shaped light guide 3, or an anisotropic diffuser for concealing optical artifacts (such as production-induced Mura patterns on the light guide 3 and/or other components in the assembly).

Two operation modes B1 and B2 differ in that, in operation mode B2, the backlight 2 is turned on and the lighting components 4a, 4b, . . . (at the coupling-in side 5 of the light guide 3) are turned off, whereas in operation mode B1, at least the lighting components 4a, 4b, . . . (at the coupling-in side 5 of the light guide 3) are turned on. Only light that was originally radiated by the lighting components 4a, 4b, . . . into the light guide 3 and subsequently emitted again via the coupling-out elements 6 is taken into account, wherein the emission occurs almost exclusively via the coupling-out elements 6.

The light guide 3 preferably consists of a transparent thermoplastic or thermoelastic polymer, e.g., plastic, or glass.

The backlight 2 includes, for example, an area light source, preferably another light guide with additional lighting components arranged laterally or on the rear side, as well as at least one light collimator integrated into the area light source and/or disposed in front thereof, such as at least one prism film and/or at least one privacy filter (e.g., a louver filter).

Accordingly, the backlight 2 may generally be configured like an LED backlight, for example as a so-called direct-lit LED backlight or an edge-lit LED backlight.

For all of the aforementioned variants of the lighting apparatus 1a, it is particularly advantageous if the apparatus further includes a transmissive screen 1 arranged in front of the lighting apparatus 1a in the viewing direction, preferably in the form of an LCD panel, which can be operated in at least two operation modes B1 for a free view mode and B2 for a limited view mode by virtue of the lighting apparatus 1a.

The lighting apparatus according to the present disclosure and the screen that can be implemented therewith solve the stated object: practically feasible solutions are described for a light guide exhibiting stable luminance uniformity over a wide viewing angle range. Luminance artifacts, such as shadow formation particularly in corners near the coupling-in edge, are largely avoided. Furthermore, the present disclosure describes a lighting apparatus which, in cooperation with a screen, enables secure display of information by means of a selectively limited viewing angle, wherein in another operation mode a free view, as unlimited in viewing angle as possible, is achievable. The present disclosure is implementable with simple means and at low cost, with the advantages of the aforementioned desired light guide being likewise realized. In both operation modes, as high a resolution as possible, up to the native resolution of the screen used, is visible. Furthermore, only a minor amount of light loss is introduced, the image quality, particularly with regard to uniformity, is high, and the limited viewing angle achieves as comprehensive a privacy protection effect as possible.

The present disclosure can be advantageously employed wherever confidential data are displayed and/or entered, such as for PIN entry or data display at automated teller machines or payment terminals, for password entry, or when reading emails on mobile devices. The present disclosure can also be used in automotive applications, as described above.

### REFERENCE SIGNS

1 Screen
1a Lighting apparatus
2 Backlight
3 Light Guide
4a Lighting component
4b Lighting component
4m Lighting component
4x End lighting component
4imagine Imaginary lighting component
5 Coupling-in side
6 Couple-out element
B Defined region
S Intersection
X Stopper
p Average center-to-center distance of lighting components 4a, 4b, . . . .

What is claimed is:

1. A plate-shaped light guide comprising two large surfaces and narrow sides connecting the large surfaces at their edges, comprising:
a plurality of individual lighting components arranged in a row, which have emission surfaces and an average center-to-center distance of p, wherein one of the narrow sides of the light guide is configured as a coupling-in side for light from the lighting components;
a plurality of coupling-out elements disposed on at least one of the large surfaces of the light guide and/or within volume thereof, wherein each of the coupling-out elements comprises at least one functional surface for defined coupling-out of light from the light guide, and all of the plurality of coupling-out elements, when projected onto one of the large surfaces, are located completely within a defined region projected onto the large surface;
an end lighting component disposed at an end of the row of the plurality of lighting components, wherein the narrow side closest to the end lighting component at the end of the row of the plurality of lighting components comprises at least one straight section, the end lighting component is aligned on the coupling-in side such that a center of a emission surface of the end lighting component is disposed at a distance p/2, with an alignment tolerance of at most ±0.3·p, from an intersection point of a projection of an imaginary extension of the longest straight section of the narrow side closest to the end lighting component at the end of the row of the lighting components with the coupling-in side, and the distance p/2 is measured along a direction of the longest extension of the coupling-in side,
so that a part of light emitted from the end lighting component into the light guide is totally reflected therein, and
for at least half of an area of the defined region of the light guide, a luminance uniformity of the light coupled out from at least one of the two large surfaces is greater than 50% at each of three angles spaced apart from one another by at least 20° and lying in a plane containing a central normal to the corresponding large surface.

2. The light guide according to claim 1, wherein the defined region has a rectangular shape, and a distance between at least one edge of the defined region and one of the narrow sides of the light guide, which does not correspond to the coupling-in side, is p/2 with a distance tolerance of at most ±0.3·p.

3. The light guide according to claim 1, wherein the coupling-out elements each have a form of prismatoids, prisms or three-dimensional structural elements with at least one curved or straight functional surface for defined coupling-out of light.

4. The light guide according to claim 1, wherein the coupling-out elements comprise diffraction structures and/or meta-structures.

5. The light guide according to claim 1, wherein the alignment tolerance is at most ±0.1·p.

6. The light guide according to claim 1, wherein the coupling-out elements are selected according to their number per unit area and their extent such that, over at least 80% of the defined region, the light guide scatters at most 25% of the light penetrating it through the large surfaces by more than 10°.

7. A lighting apparatus for a screen adapted to operate in at least two operation modes comprising a first operation mode B1 for a free view mode and a second operation mode B2 for a limited view mode, in which light is emitted by the lighting apparatus within a limited viewing angle range compared to the free view mode, the lighting apparatus comprising:
a planar backlight configured to emit light into a limited viewing angle range, and
the plate-shaped light guide according to claim 1 disposed in front of the backlight in a viewing direction, with the lighting components arranged on the narrow side serving as the coupling-in side,
wherein in the second operation mode B2, the backlight is turned on and the lighting components are turned off, and in the first operation mode B1, at least the lighting components are turned on.

8. The lighting apparatus according to claim 7, wherein the light guide has a stronger scattering property in a selectable direction than in a direction perpendicular thereto.

9. The lighting apparatus according to claim 8, wherein the selectable direction corresponds to a vertical direction when an observer looks at the lighting apparatus, so that the scattering property of the light guide is greater in the vertical direction than in a horizontal direction parallel to a line between eyes of the observer.

10. The lighting apparatus according to claim 7, wherein the defined region is divided into sub-regions of a predetermined size, and a ratio of a surface area of functional surfaces in one of the sub-regions to a surface area of the sub-region differs among different sub-regions, so that the scattering property of the light guide varies over the defined region.
